(19) United States
(12) Patent Application Publication
(10) Pub. No.: US 2025/0342175 A1
(43) Pub. Date: Nov. 6, 2025

(54) TECHNIQUES FOR DYNAMICALLY SCALING HARDWARE CAPACITY USED TO HOST DATA PARTITIONS OF A DATABASE

(71) Applicant: MongoDB, Inc., New York, NY (US)

(72) Inventors: Jack Wearden, Altrincham (GB); Giedrius Rekasius, Dublin (IE); Vicente Fernández, Madrid (ES); Kevin Pytlar, Brooklyn, NY (US); Yu-Chien Linda Kao, Brooklyn, NY (US); Phuong-Thao (Sue) Nguyen, San Francisco, CA (US); Christopher Shum, New York, NY (US)

(21) Appl. No.: 19/194,833

(22) Filed: Apr. 30, 2025

Related U.S. Application Data
(60) Provisional application No. 63/640,986, filed on May 1, 2024.
(60) Provisional application No. 63/640,978, filed on May 1, 2024.

(51) Int. Cl. G06F 16/27

(52) U.S. Cl. CPC G06F 16/278

(57) ABSTRACT

Some embodiments provide a system for optimizing the operational efficiency of a distributed database system configured to store data divided among a plurality of data partitions. The distributed database system comprises database hardware for hosting the plurality of data partitions. The system determines, for each of multiple data partitions, a hardware capacity for hosting the data partition. The system configures the database hardware based on hardware capacities determined for hosting the data partitions.

### RELATED APPLICATIONS

This application claims priority under 35 U.S.C. § 119 (e) to U.S. Provisional Application Ser. No. 63/640,986, entitled “TECHNIQUES FOR DYNAMICALLY SCALING HARDWARE CAPACITY USED TO HOST DATA PARTITIONS OF A DATABASE,” filed on May 1, 2024. This application claims priority under 35 U.S.C. § 119 (e) to U.S. Provisional Application Ser. No. 63/640,978, entitled “SYSTEMS AND METHODS FOR DISTRIBUTED CATCHALL DATABASE,” filed on May 1, 2024. Each of which is herein incorporated by reference in their entirety.

### BACKGROUND

Database sharding involves dividing data of the database across multiple different database servers. A single database server has a limited amount of storage capacity. Thus, as the amount of data stored in the database grows larger, the data needs to be divided into multiple partitions (which also may be referred to as “chunks”). The smaller data partitions are stored across multiple database servers (“shards”). Each shard may store a respective data partition in its storage hardware and execute operations on the data partition (e.g., to generate responses to queries on data in the data partition).

### SUMMARY

Today, users leverage sharding as a way to horizontally scale their database. Sharding allows users to spread their collection data and workload across multiple servers/shards. Users can shard one or more collections of data. The more collections they shard, the better the distribution of data and workload across the shards.

In practice, only a limited number of collections of data in a database are sharded. All unsharded collections for a database may live on the same shard. These unsharded collections can lead to some shards needing more resources than others, especially if the unsharded collections are relatively large or “hot”. However, currently, computing resources (e.g., cluster tiers and disk performance) have to be uniform since they are applied at the cluster level. An auto-scaler applies the same symmetry when it scales a cluster, meaning it scales all the nodes within the cluster to the same cluster tier on all the shards.

Some embodiments provide a system for optimizing operational efficiency of a distributed database system configured to store data divided among a plurality of data partitions. The distributed database system comprises database hardware for hosting the plurality of data partitions. The system determines, for each of multiple data partitions, a hardware capacity for hosting the data partition. The system configures the database hardware based on hardware capacities determined for hosting the data partitions.

Some embodiments provide a system for scaling hardware capacity in a distributed database system configured to store data divided among a plurality of data partitions. The distributed database system comprises database hardware for hosting the plurality of data partitions. The system comprises at least one processor; and at least one non-transitory computer-readable storage medium storing instructions. The instructions, when executed by the at least one processor, cause the at least one processor to: determine, for each of at least some of the plurality of data partitions, a hardware capacity for hosting the data partition, the determining comprising: determine a first hardware capacity for hosting a first data partition of the plurality of data partitions; and determine a second hardware capacity, different from the first hardware capacity, for hosting a second data partition of the plurality of data partitions; and configure the database hardware based on hardware capacities determined for hosting the at least some data partitions, the configuring comprising: configure a first set of the database hardware, having the first hardware capacity, to host the first data partition; and configure a second set of the database hardware having the second hardware capacity to host the second data partition.

Some embodiments provide a method for scaling hardware capacity in a distributed database system configured to store data divided among a plurality of data partitions. The distributed database comprises database hardware for hosting the plurality of data partitions. The method comprises using at least one processor to perform: determining, for each of at least some of the plurality of data partitions, a hardware capacity for hosting the data partition, the determining comprising: determining a first hardware capacity for hosting a first data partition of the plurality of data partitions; and determine a second hardware capacity, different from the first hardware capacity, for hosting a second data partition of the plurality of data partitions; and configuring the database hardware based on hardware capacities determined for hosting the at least some data partitions, the configuring comprising: configuring a first set of the database hardware, having the first hardware capacity, to host the first data partition; and configuring a second set of the database hardware having the second hardware capacity to host the second data partition.

Some embodiments provide a distributed database system configured to store data divided among a plurality of data partitions. The distributed database system comprises: database hardware configured to host the plurality of data partitions, wherein the database hardware is configurable to provide different hardware capacities for hosting different data partitions; and at least one processor configured to dynamically modify a configuration of the database hardware to update a hardware capacity used to host a particular data partition of the plurality of data partitions.

The foregoing summary is non-limiting.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A is an example database system including a hardware capacity scaling system, according to some embodiments of the technology described herein.

FIG. 1B shows the hardware capacity scaling system of FIG. 1A configuring a set of database hardware to host a data partition, according to some embodiments of the technology described herein.

FIG. 2 is an example process for optimizing operational efficiency of a distributed database system configured to store data divided among multiple data partitions, according to some embodiments of the technology described herein.

FIG. 3 shows a block diagram of an exemplary computer system improved by the implementation of any functions and/or operations of embodiments of the technology described herein.

FIG. 4 shows an example graphical user interface (GUI) through which hardware capacity scaling can be configured for shards of a database system, according to some embodiments of the technology described herein.

FIG. 5 shows an example GUI through which hardware capacity scaling can be configured for a cluster of shards of a database system, according to some embodiments of the technology described herein.

### DETAILED DESCRIPTION

The inventors have developed techniques for scaling hardware capacity in a distributed database system configured to store data divided among multiple data partitions (also referred to as “chunks”). Hardware capacity may refer to computing performance and/or storage (e.g., disk) input/output performance provided by a set of database hardware (e.g., one or more servers). The techniques determine a hardware capacity for each data partition and configure database hardware to provide the hardware capacity determined for the data partition. The techniques may configure the database hardware to host different data partitions with different hardware capacities.

Database sharding allows users of a database to divide the database into multiple data partitions that are hosted by different systems (e.g., database servers). Sharding may be used, for example, when storage on a given server is nearing capacity and/or to more uniformly distribute data across multiple servers. Sharding further allows the volume of data stored in a database to increase without overloading a single machine. For example, in the context of a MongoDB database, a collection of documents in the database can be divided into multiple different shards, where each shard is hosted by a different set of one or more servers. Each set of server(s) may store the shard data and execute operations involving data in the shard (e.g., execute queries targeting data of the shard).

The inventors have recognized a problem that often occurs when a database is sharded into multiple data partitions. When data of a database is sharded, either in part or whole, all of the data partitions are hosted with database hardware having the same hardware capacity (e.g., processing power, amount of memory, and/or disk read/write speed). Typically, one or more data partitions require more hardware capacity than other data partitions because the data partition(s) store a larger volume of data, operations are executed more frequently on the data partition(s), and/or operations executed on the data partition(s) are more complex than those executed on other data partitions. To ensure that there is sufficient hardware capacity to support the data partition(s) that demand higher hardware capacity, the database is configured with the higher hardware capacity to host all data partitions, including those that do not require the hardware capacity to operate (e.g., because the data partitions do not store as much data, operations are executed less frequently on the data partitions, and/or operations executed on the data partitions are not generally as complex as those executed on the other data partition). This leads to a database system using higher hardware capacity than it needs to host much of its data, resulting in a waste of computing and/or storage resources as well as higher operating costs for users of the database system.

Accordingly, the inventors have developed techniques that address the above-described problem that often occurs in sharded database systems. The techniques configure a database system such that it can be configured to use different hardware capacities to host different data partitions. This allows data partitions that require a higher hardware capacity (e.g., higher compute performance and/or storage device performance) to be hosted using hardware with higher capacity. Likewise, data partitions that require a lower hardware capacity (e.g., lower compute performance and/or storage device performance) can be hosted using hardware with lower hardware capacity. By allowing variability in hardware capacity used to host different data partitions, embodiments described herein reduce the waste of computing and storage resources by assigning hardware capacity to data partitions with higher granularity that reduces waste of computing and/or storage resources.

Some embodiments provide a system for automatically scaling hardware capacity in a distributed database system that stores data divided among multiple data partitions. The system automatically determines different hardware capacities (e.g., computing performance tiers and/or disk read/write performance) for data partitions by analyzing operations performed on the data partitions. The system may be configured to determine different hardware capacities for different data partitions and to configure database hardware accordingly to host the different data partitions. For example, a data partition storing near-term transaction data that is frequently updated by an application may be hosted using database hardware with higher hardware capacity than another data partition storing historical transaction data that is less frequently accessed by the application.

Some embodiments provide a distributed database system configured to store data divided among a plurality of data partitions. The distributed database system comprises database hardware configured to host the plurality of data partitions, wherein the database hardware is configurable with different hardware capacities for hosting different data partitions. The distributed database system may be configured to dynamically modify a configuration of the database hardware to update a hardware capacity used to host a particular data partition of the plurality of data partitions.

Following below are more detailed descriptions of various concepts related to, and embodiments of, hardware capacity scaling systems and methods developed by the inventors. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

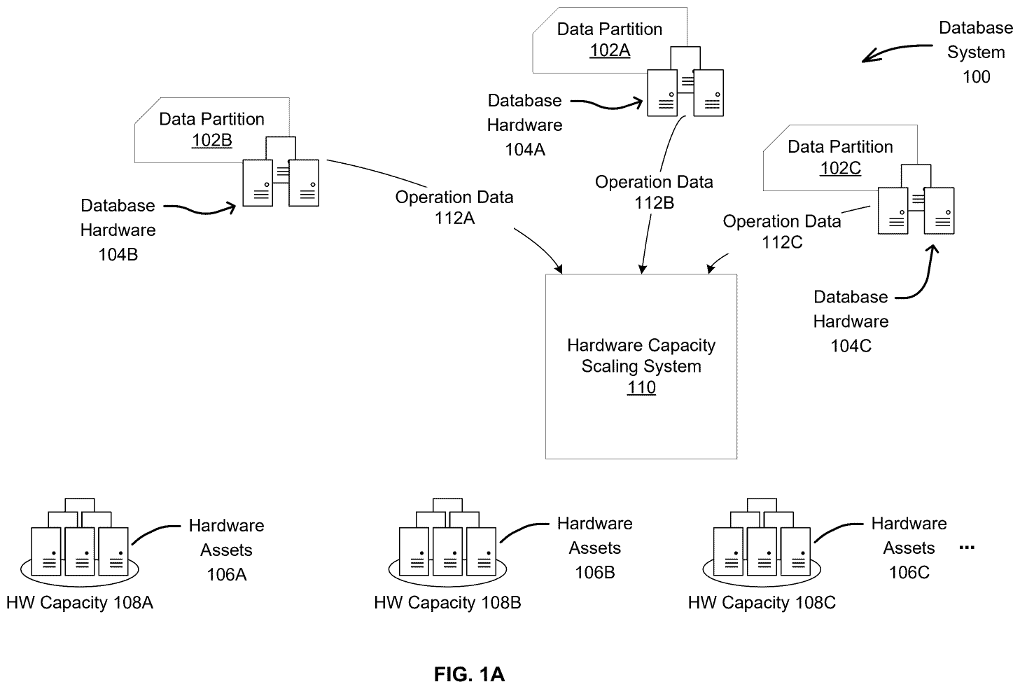

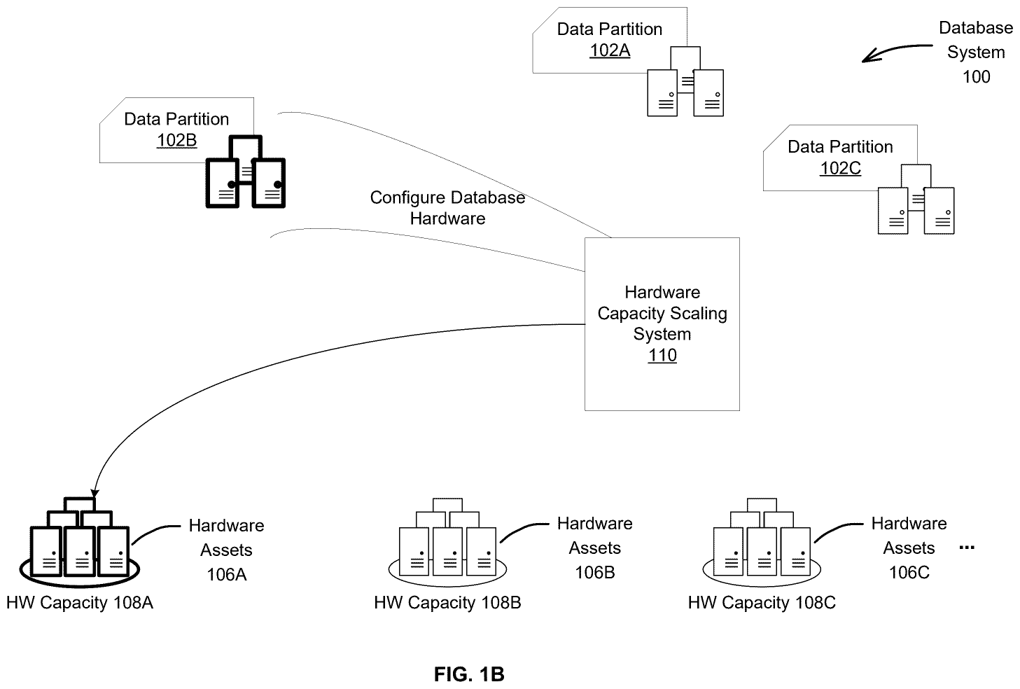

FIG. 1A is an example database system 100 including a hardware capacity scaling system 110, according to some embodiments of the technology described herein. As shown in FIG. 1A, the database system stores data divided into multiple data partitions 102A, 102B, 102C that are hosted by respective sets of database hardware 104A, 104B, 104C. The database system 100 has database hardware assets 106A, 106B, 106C with respective hardware capacities 108A, 108B, 108C. Hardware capacity scaling system 110 may be configured to configure database hardware (e.g., from hardware asset sets 106A, 106B, 106C) to host data partitions 102A, 102B, 102C.

In some embodiments, hardware capacity scaling system 110 may be configured to determine a hardware capacity for hosting each of data partitions 102A, 102B, 102C. Hardware capacity scaling system 110 may be configured to determine different hardware capacities for different ones of the data partitions 102A, 102B, 10C, and configure database hardware based on the different hardware capacities. Hardware capacity scaling system 110 may be configured to configure a set of database hardware for each of the data partitions 102A, 102B, 102C that has the hardware capacity determined for the data partition. To illustrate, database hardware 104A may have a higher hardware capacity than database hardware 104B. For example, servers of database hardware 104A, may have higher performing central processing unit (CPU) hardware than servers of database hardware 104B. As another example, servers of database hardware 104A may have more CPU cores than servers of database hardware 104B. As another example, servers of database hardware 104A may have more random access memory (RAM) per CPU core than database hardware 104B. As another example, the disks of database hardware 104A may have better read/write performance than the disks of database hardware 104B.

In some embodiments, hardware capacity scaling system 110 may be configured to automatically determine a hardware capacity for hosting a particular data partition. In some embodiments, hardware capacity scaling system 110 may be configured to determine the hardware capacity for the particular data partition based on a history of operations performed on the data partition (also referred to as a “look-back window”). For example, hardware capacity scaling system 110 may determine CPU utilization and/or memory usage of database hardware configured to host the data partition over a time period. In some embodiments, the time period may be 0-1 hours, 1-2 hours, 2-3 hours, 3-4 hours, 4-5 hours, 5-6 hours, 6-12 hours, 12-24 hours, 1-2 days, 1-7 days, 7-30 days, 1-6 months, 6-12 months, 1 to 5 years, or another time period. For example, the time period may be 1 hour. In some embodiments, hardware capacity scaling system 110 may be configured to determine: (1) whether a CPU utilization and/or memory usage for the data partition has reached a threshold level; and (2) modify the hardware capacity assigned for the data partition when it is determined that the CPU utilization and/or memory usage has reached the threshold level. For example, hardware capacity scaling system 110 may be configured to increase the hardware capacity if CPU utilization and/or memory usage is above a threshold (e.g., a threshold in one of ranges 70-80%, 80-90%, 90-100%, or another threshold). As another example, hardware capacity scaling system 110 may be configured to decrease the hardware capacity for the data partition if CPU utilization and/or memory usage is below a threshold (e.g., a threshold in one of ranges 10-20%, 20-30%, 30-40%, 40-50%, 50-60%, or another threshold).

In some embodiments, hardware capacity scaling system 110 may be configured to increase a hardware capacity for hosting a data partition and/or decrease a hardware capacity for hosting the data partition. In some embodiments, hardware capacity scaling system 110 may be configured to determine whether to increase hardware capacity based on a history of operations performed on the data partition over a first time period (e.g., 1 hour). For example, hardware capacity scaling system 110 may determine CPU utilization and/or memory usage during the first time period and determine whether to increase hardware capacity based on the CPU utilization and/or memory (e.g., by determining whether the CPU utilization and/or memory usage has reached a threshold level in the first time period). In some embodiments, hardware capacity scaling system 110 may be configured to determine whether to decrease hardware capacity based on a history of operations performed on the data partition over a second time period (e.g., 24 hours). For example, hardware capacity scaling system 110 may determine CPU utilization and/or memory usage during the second time period and determine whether to decrease hardware capacity based on the CPU utilization and/or memory (e.g., by determining whether the CPU utilization and/or memory usage has reached a threshold level in the second time period). In some embodiments, the first time period is different from the second time period. For example, the first time period (e.g., 1 hour) may be shorter than the second time period (e.g., 24 hours). In some embodiments, the first time period and the second time period are the same.

In some embodiments, hardware capacity scaling system 110 may be configured to configure database hardware of database system 100 to initially host a data partition with a default hardware capacity. In some embodiments, hardware capacity scaling system 110 may be configured to configure database hardware of database system 100 to host a data partition (e.g., a new data partition for which there is no operation history) with a hardware capacity based on an expected operation load determined from other data partitions (e.g., for which there is a history of operations).

In some embodiments, hardware capacity scaling system 110 may be configured to determine a hardware capacity for hosting a data partition based on user input. For example, the hardware capacity scaling system 110 may receive user input indicating a minimum and/or maximum hardware capacity for a data partition (e.g., a minimum and/or maximum IOPS performance, a minimum and/or maximum amount of RAM, and/or a minimum and/or maximum CPU performance). Hardware capacity scaling system 110 may configure database hardware of database system 100 to be within hardware capacity limit(s) (e.g., a minimum and/or maximum hardware capacity parameter) when scaling hardware capacity for the data partition.

In some embodiments, hardware capacity scaling system 110 may be configured to dynamically scale hardware capacity used to host data partitions 102A, 102B, 102C. Hardware capacity scaling system 110 may analyze a log of operations executed on each data partition 102A, 102B, 102C and determine a measure of hardware resource utilization (e.g., percentage of CPU utilization and/or memory utilization) of database hardware that is currently being used to hose the data partition. Hardware capacity scaling system 110 may be configured to update hardware capacity for the data partition in response to detecting a change in hardware capacity needed for the data partition. FIG. 1B shows the hardware capacity scaling system 110 of FIG. 1A dynamically configuring database hardware for hosting data partition 102B, according to some embodiments of the technology described herein.

In the example of FIG. 1B, hardware capacity scaling system 110 may determine that the hardware capacity for hosting data partition 102B is to change (e.g., increase or decrease). Hardware capacity scaling system 110 may determine that the previous hardware capacity is insufficient or excessive. For example, hardware capacity scaling system 110 may determine that CPU and/or memory utilization of hardware currently hosting data partition 102B has been above a threshold level (e.g., 95%, 90%, 85%, 80%, 75%, 70%, or a suitable threshold between 70-100%) for a time period (e.g., the past 1 hour, 1.5 hours, 2 hours, 3 hours, 4 hours, 5 hours, or a suitable time period between 0-5 hours). As another example, hardware capacity scaling system 110 may determine that CPU and/or memory utilization of hardware currently hosting data partition 102B has been below a threshold level (e.g., 40%, 35%, 30%, 25%, 20%, 15%, 10%, or a suitable threshold between 0-40%) for a time period (e.g., 6 hours, 5 hours, 4 hours, 3 hours, 2 hours, 1 hour, or a time suitable time period between 1-6 hours). When hardware capacity scaling system 110 determines that hardware capacity for hosting data partition 102B is to change, hardware capacity scaling system 110 may configure a different set of database hardware to host data partition 102B. In the example of FIG. 1B, hardware capacity scaling system 110 configures database hardware from hardware assets 106A with hardware capacity 108A to host data partition 102B.

In some embodiments, hardware capacity scaling system 110 may determine a hardware capacity for hosting a data partition by selecting one of multiple tiers of hardware capacity (e.g., based on CPU and/or memory utilization). For example, the multiple tiers of hardware capacity may be different cluster tiers that each provide a level of memory, storage, CPU performance, and/or IOPS performance. In some embodiments, hardware capacity scaling system 110 may be configured to automatically increase or decrease a hardware capacity for hosting a data partition from one of the tiers to another tier (e.g., a higher tier or a lower tier). Accordingly, hardware capacity scaling system 110 may dynamically transition database hardware used to host the data partition (e.g., based on changing operational use of the data partition and/or content of data stored in the data partition). Hardware capacity scaling system 110 may thus evolve database hardware configuration with time to mitigate wasted hardware capacity (e.g., on data partitions that use little capacity) and ensure that performance requirements are met (e.g., for data partitions that require high performance).

In some embodiments, database system 100 may be a cloud-based database system in which hardware resources are designated by a cloud provider system. Hardware capacity scaling system 110 may be configured to configure database hardware for hosting data partitions by transmitting requests to a cloud provider system (e.g., Amazon Web Services (AWS) cloud storage system, Google cloud storage system, and/or another cloud provider system). For example, hardware capacity scaling system 110 may transmit an application programming interface (API) call to the cloud provider system to change a hardware capacity for hosting data partition 102B. The cloud provider system may abstract the assignment of physical hardware resources from database system 100. For example, hardware capacity scaling system 110 may transmit an indication of a hardware capacity tier to use for hosting data partition 102B and the cloud provider system may handle the coordination of physical hardware resources to host data partition 102B.

After configuring performed by hardware capacity scaling system 110, database hardware of database system 100 may be reconfigured to host data partition 102B with the updated hardware capacity. For example, data partition 102B may now be hosted using hardware of higher computing performance and/or disk storage performance. This may facilitate scaling operations on data partition 102B up (e.g., to account for greater traffic in an application that stores data in data partition 102B).

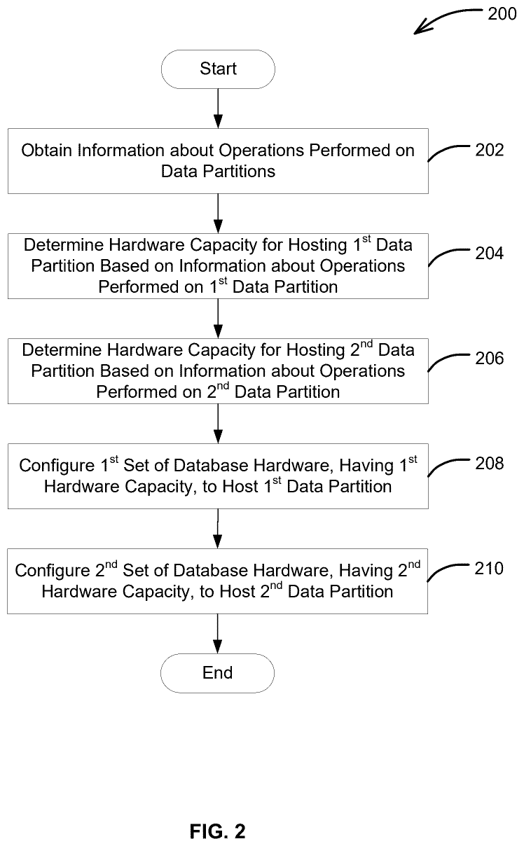

FIG. 2 is an example process 200 for optimizing operational efficiency of a distributed database system (e.g., database system 100) configured to store data divided among multiple data partitions, according to some embodiments of the technology described herein. In some embodiments, process 200 may be performed by hardware capacity scaling system 110 described herein with reference to FIGS. 1A-1B. For example, process 200 may be performed by hardware capacity scaling system 110 to configure database hardware for hosting data partitions 102A, 102B. In some embodiments, process 200 may be performed periodically by the system to dynamically update hardware capacity for the data partitions to mitigate the waste of hardware capacity on a data partition and/or ensure adequate hardware capacity for a data partition. In one example, the process 200 may be performed to automatically scale hardware capacity shards of a MongoDB Atlas database system. In this example, the system may assign a given shard to one of multiple tiers (e.g., “cluster tiers”) to scale the shard to a particular hardware capacity.

Process 200 begins at block 202, where the system obtains information about operations performed on multiple data partitions (e.g., two or more data partitions). In some embodiments, the system may be configured to obtain information about hardware utilization for performing operations. For example, the system may obtain CPU and/or memory utilization of database hardware currently configured to host the data partitions in performing the operations. As another example, the system may obtain logs of the operations and compute statistics indicating hardware usage of the database hardware currently configured to host the data partitions. In some embodiments, the information about hardware utilization may include information about memory utilization. For example, the system may use a formula to calculate the memory utilization.

Next, process 200 proceeds to block 204, where the system determines hardware capacity for a first data partition (e.g., a first shard). The system may determine a hardware capacity for the first data partition. The system may determine a hardware capacity for the first data partition based on information about operations performed on the first data partition. For example, the system may determine CPU utilization and/or memory utilization of the database hardware performing the operations on a particular data partition, and determine a hardware capacity for the data partition based on the CPU and/or memory utilization. Example techniques of using CPU and/or memory utilization to determine a hardware capacity are described herein. To illustrate, the system may determine that the CPU and/or memory utilization has exceeded 90% in the past hour and determine to increase the hardware capacity to a higher one (e.g., the next tier up) of multiple tiers of hardware capacity in response to doing so. As another example, the system may determine that the CPU and/or memory utilization has been below 30% for 4 hours and determine to decrease the hardware capacity to a lower one (e.g., the next tier below) of multiple tiers of hardware capacity. As another example, the system may determine the hardware capacity for the first data partition based on user input (e.g., limiting the hardware capacity by a minimum and/or maximum hardware capacity specified by a user). As another example, the system may determine the hardware capacity for the first data partition by calculating a target hardware capacity based on collected statistics.

Next, process 200 proceeds to block 206, where the system determines a hardware capacity for hosting a second data partition based on information about operations performed on the second data partition (e.g., obtained from a set of database hardware currently configured to host the second data partition). The system may determine the hardware capacity as described herein with reference to block 204. For example, the system may determine CPU utilization and/or memory utilization of the database hardware performing the operations on the second data partition, and determine a hardware capacity for the second data partition based on the CPU and/or memory utilization. Example techniques of using CPU and/or memory utilization to determine a hardware capacity are described herein. To illustrate, the system may determine that the CPU and/or memory utilization has exceeded 90% in the past hour and determine to increase the hardware capacity to a higher one (e.g., the next tier up) of multiple tiers of hardware capacity in response to doing so. As another example, the system may determine that the CPU and/or memory utilization has been below 30% for 4 hours and determine to decrease the hardware capacity to a lower one (e.g., the next tier below) of multiple tiers of hardware capacity. As another example, the system may determine the hardware capacity for the first data partition based on user input (e.g., specifying a particular CPU performance and/or disk performance). As another example, the system may determine the hardware capacity for the second data partition by calculating a target hardware capacity based on collected statistics.

Next, process 200 proceeds to block 208, where the system configures a first set of database hardware having the first hardware capacity determined for the first data partition to host the first data partition. For example, the system may designate a first set of servers, having the first hardware capacity, to host the first data partition. As another example, the system may transmit a request (e.g., an API call) to a cloud provider system to configure cloud-based hardware resources having the first hardware capacity to host the data partitions. In some embodiments, the system may be configured to configure the first set of database hardware for the first data partition by assigning a particular hardware capacity tier (e.g., a cluster tier) to the first data partition (e.g., the first shard). Assignment of the particular hardware capacity tier may trigger configuration of the first set of database hardware having the first hardware capacity determined for the first data partition to host the first data partition.

Next, process 200 proceeds to block 210, where the system configures a second set of database hardware having the second hardware capacity determined for the second data partition to host the second data partition. For example, the system may designate a second set of servers, having the second hardware capacity, to host the second data partition. As another example, the system may transmit a request (e.g., an API call) to a cloud provider system to configure cloud-based hardware resources having the second hardware capacity to host the data partitions. In some embodiments, the system may be configured to configure the second set of database hardware for the second data partition by assigning a particular hardware capacity tier (e.g., a cluster tier) to the second data partition (e.g., the first shard). Assignment of the particular hardware capacity tier may trigger configuration of the second set of database hardware having the second hardware capacity determined for the second data partition to host the second data partition.

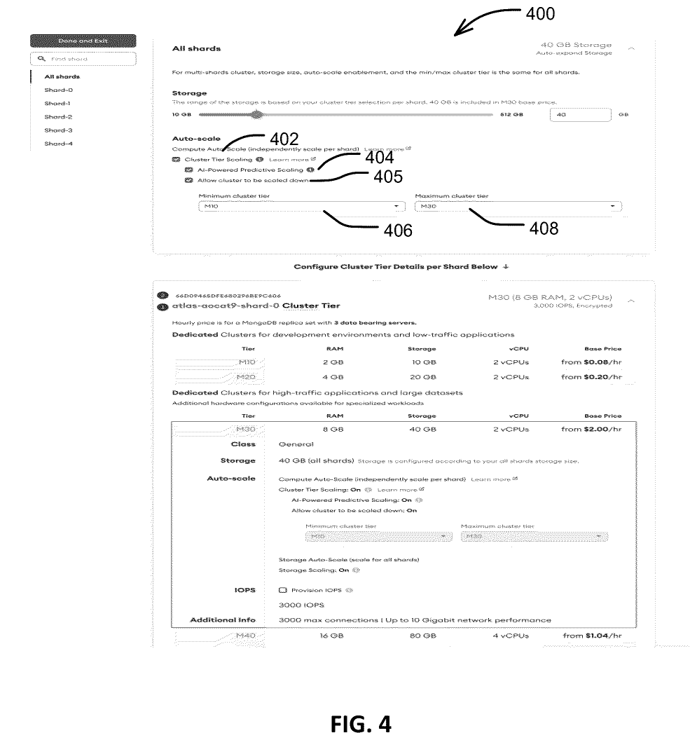

FIG. 4 shows an example graphical user interface (GUI) 400 through which hardware capacity scaling can be configured for shards of a database system, according to some embodiments of the technology described herein. As shown in FIG. 4, the GUI 400 includes selectable options to configure automatic hardware capacity scaling for the shards. The options include an option 402 to enable scaling of hardware capacity. In the example of FIG. 4, the hardware capacity for each of the shards can be scaled to different cluster tiers. Each of the cluster tiers may provide a different hardware capacity (e.g., RAM, amount of storage, and/or number of vCPUs). Example cluster tiers include tiers M10, M20, M30, and M40 as listed in the GUI 400 shown in FIG. 4. The options in the GUI 400 further include an option 404 that enables predictive scaling using artificial intelligence (AI). The options further include an option 405 to allow a cluster tier for a shard to be scaled down. The GUI 400 provides an input field 406 to configure a minimum cluster tier and an input field 408 maximum cluster tier to which a shard can be scaled. In the example of FIG. 4, the user has set the minimum cluster tier to M10 and the maximum cluster tier to M30. Accordingly, a shard may be scaled to the minimum cluster tier, maximum cluster tier, or a cluster tier in between the minimum and maximum cluster tiers.

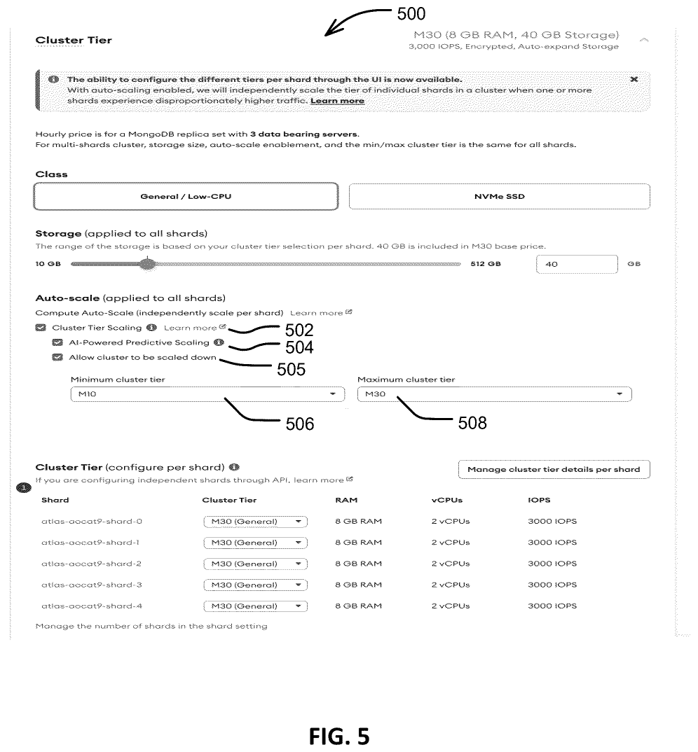

FIG. 5 shows an example GUI 500 through which hardware capacity scaling can be configured for shards of a database system, according to some embodiments of the technology described herein. The options include an option 502 to enable automatic hardware capacity scaling for the shards. Thus, each shard may be scaled to a different cluster tier. The options further include an option 504 to enable AI-based predictive scaling of cluster tiers for a shard. The options further include an option 505 that allows a cluster tier for a shard to be scaled down. The GUI 500 provides an input field 506 to configure a minimum cluster tier and an input field 508 maximum cluster tier to which a shard can be scaled. In the example of FIG. 5, the user has set the minimum cluster tier to M10 and the maximum cluster tier to M30. Accordingly, a shard may be scaled to the minimum cluster tier, maximum cluster tier, or a cluster tier in between the minimum and maximum cluster tiers.

### Example Implementations

Some embodiments of the technology described herein may be implemented in a MongoDB Atlas database system. Hardware capacity of shards in an Atlas database system may be automatically scaled using techniques described herein. A shard may be scaled independently of other shards (e.g., other shards in a cluster to which the shard belong). Workload on the shard may be used to determine its hardware capacity. For example, the workload on the shard may be used to determine which of multiple hardware capacity tiers to assign to the shard. In some embodiments, the cluster tier ranges that Atlas uses to automatically scale cluster tier, storage capacity, or both in response to cluster usage may be configured. Atlas auto-scaling adjusts cluster tier based on real-time resource usage. The auto-scaling engine can accurately detect sustained higher demand and short-term peak traffic for upscaling decisions. Similarly, Atlas makes downscaling choices more promptly, for more optimized resource utilization and cost profile.

To help control costs, in some embodiments, a user can specify a range of maximum and minimum cluster sizes that shards in a cluster of shards can automatically scale to. In some embodiments, auto-scaling works on a rolling basis, and the process doesn't incur any downtime. Atlas may maintain a primary during this process but the nodes are upgraded one by one and will be unavailable while being upgraded.

In some embodiments, Atlas analyzes the following cluster metrics to determine when to scale a cluster, and whether to scale the cluster tier up or down: normalized system CPU utilization and system memory utilization. For example, Atlas calculates system System Memory Utilization based on available node memory and total memory as follows: (memoryTotal−(memoryFree+memory Buffers+memoryCached))/(memoryTotal)*100. In this equation, memory Free, memoryBuffers, and memoryCached are amounts of available memory that Atlas can reclaim for other purposes. In some embodiments, Atlas won't scale your cluster tier if the new cluster tier would fall outside of your specified minimum and maximum cluster size range.

In some embodiments, Atlas may be configured to scale a cluster to another tier in the same class. For example, Atlas may be configured to scale general clusters to other general cluster classes, but doesn't scale general clusters to low-CPU cluster classes. In some embodiments, auto-scaling criteria are subject to change in order to ensure appropriate cluster resource utilization.

As an illustrative example, if the next cluster tier is within a specified maximum cluster size range, Atlas scales operational nodes in a cluster up to the next tier if at least one of the following criteria is true for any cluster node of this type.
M10 and M20 clusters:
   AWS. The average normalized Relative System CPU Utilization has exceeded 90% for the past 20 minutes and the average non-normalized Absolute System CPU Utilization for CPU steal has exceeded 30% for the past 3 minutes.
   Azure. The average normalized Relative System CPU Utilization has exceeded 90% for the past 20 minutes and the average non-normalized Absolute System CPU Utilization for softIRQ has exceeded 10% for the past 3 minutes.
   The average normalized Absolute System CPU Utilization has exceeded 90% of resources available to the cluster for the past 20 minutes.
   The average normalized Relative System CPU Utilization has exceeded 75% of resources available to the cluster for the past one hour.
   The average System Memory Utilization has exceeded 90% of resources available to the cluster for the past 10 minutes. To learn how Atlas calculates the amount of system memory utilization, see How Atlas Scales Cluster Tier.
   The average System Memory Utilization has exceeded 75% of resources available to the cluster for the past one hour.
M30+ clusters:
   The average System CPU Utilization has exceeded 90% of resources available to the cluster for the past 10 minutes.
   The average System CPU Utilization has exceeded 75% of resources available to the cluster for the past one hour.
   The average System Memory Utilization has exceeded 90% of resources available to the cluster for the past 10 minutes.
   The average System Memory Utilization has exceeded 75% of resources available to the cluster for the past one hour.

The above thresholds ensure that a cluster scales up quickly in response to high loads, and an application can handle spikes in traffic or usage, maintaining its performance and reliability. In some embodiments, for analytics nodes on any cloud provider, Atlas may scale them up to the next tier if the average normalized System CPU Utilization or the System Memory Utilization has exceeded 75% of resources available to any cluster node for the past one hour.

In some embodiments, to achieve optimal resource utilization and cost profile, Atlas avoids scaling up the cluster to the next tier if: (1) the M10 or M20 cluster has been scaled up in the past 20 minutes or one hour, depending on thresholds, or (2) the M30+ cluster has been scaled up in the past 10 minutes or one hour, depending on thresholds. For example, if the cluster tier has not been changed since 12:00, Atlas will scale an M30+ cluster at 12:10, if the cluster's current normalized System CPU Utilization is greater than 90%.

In some embodiments, scaling up to a greater cluster tier requires enough time to prepare backing resources. Automatic scaling may not occur when a cluster receives a burst of activity, such as a bulk insert. To reduce the risk of running out of resources, plan to scale up clusters before bulk inserts and other workload spikes.

In some embodiments, Atlas scales down nodes in your cluster under the conditions. For example, if the next lowest cluster tier is within a specified minimum cluster size range, Atlas scales the nodes in a cluster down to the next lowest tier if all of the following criteria are true for all nodes of the specified cluster type:
All nodes:
   Atlas hasn't scaled the cluster down (manually or automatically) in the past 24 hours.
   Atlas hasn't provisioned or unpaused the cluster in the past 24 hours.
Operational nodes:
   The average normalized System CPU Utilization is below 45% of resources available to the cluster over at least the last 10 minutes AND the last 4 hours. Atlas uses the “4 hours average” checkpoint as an indication that the CPU load has settled down on the observed level. Atlas uses the “10 minutes average” checkpoint as an indication that no recent CPU spikes have occurred that Atlas didn't capture with the “4 hour average” checkpoint.
   The average WiredTiger cache usage is below 90% of the maximum WiredTiger cache size for at least the last 10 minutes AND the last 4 hours at the current cluster tier size. This indicates to Atlas that the current cluster isn't overloaded.
   The projected total System Memory Utilization at the new lower cluster tier is below 60% for at least the last 10 minutes AND the last 4 hours. Atlas calculates the projected total memory usage mentioned in the preceding statement as follows.
Analytics nodes:
   The average Normalized System CPU Utilization and System Memory Utilization over the past 24 hours is below 50% of resources available to the cluster.

In some embodiments, Atlas measures the current memory usage and replaces the current WiredTiger cache usage size with 80% of the WiredTiger cache size on the new lower tier cluster. Next, Atlas checks whether the projected total memory usage would be below 60% for at least the last 4 hours and at least the last 10 minutes on the new tier size. In some embodiments, Atlas includes the WiredTiger cache in its memory calculation to make it more likely that clusters with a full cache, but otherwise low traffic, will scale down. In other words, Atlas examines the size of the WiredTiger cache to determine that it can safely down scale an otherwise idle cluster with low Normalized System CPU Utilization in cases where the cluster's WiredTiger caches might reach 90% of the cluster's maximum WiredTiger cache size. The above conditions ensure that Atlas scales down operational nodes in your cluster to prevent high utilization states.

Some example considerations for downward auto-scaling of cluster tier and storage include:
When Atlas scales down the storage capacity of your cluster, this can take longer than expanding storage capacity due to the mechanics of the scaling process.
Estimate a deployment's range of workloads and then set the Minimum Cluster Size value to the cluster tier that has enough capacity to handle the deployment's workload. Account for any possible spikes or dips in cluster activity.
A minimum cluster tier that is below the current disk configuration of a cluster cannot be selected. If storage increases beyond what is supported by the minimum cluster tier, Atlas increases the clusters storage configuration beyond what the minimum cluster tier supports, then Atlas automatically adjusts the minimum cluster tier to a tier that supports the current storage requirements of the cluster.

For example, the auto-scaling bounds are set to M20-M60 and the current cluster tier is M40 with a disk capacity of 200 GB. Atlas triggers a disk auto-scaling event to increase capacity to 320 GB because current disk usage exceeds 180 GB, which is more than 90% of the 200 GB capacity.

Atlas may:
1. Raise the minimum cluster tier to the next lowest tier, M30, that can accommodate the new storage capacity. M20 supports a maximum storage capacity of 256 GB, so it is no longer a valid auto-scaling bound.
2. Determine that the current instance size, M40, supports the new disk configuration. The disk auto-scaling event succeeds.

In some embodiments, Atlas auto-scales the cluster tier for sharded clusters using the same criteria as replica sets. Atlas may, for example, apply the following rules:
If the operational or analytics nodes within a shard meet the criteria to auto-scale, only the operational/analytics nodes on that particular shard will change tier.
The Config server replica set doesn't auto-scale.

In some embodiments, the cluster tier of each shard can be scaled individually. An API is capable of describing asymmetric clusters. For example, each shard is specified by a separate replicationSpec.

In some embodiments, if Atlas attempts to scale the cluster tier down and the target tier can't support the current disk capacity, provisioned IOPS, or both, Atlas doesn't scale the cluster down. In this scenario, Atlas updates auto-scaling settings based on the relationship between the current cluster tier and the configured maximum cluster tier:
Atlas disables the cluster from automatically scaling down because all smaller tiers wouldn't be able to accommodate the necessary storage settings. Downward auto-scaling may be re-enabled.
If the cluster isn't currently at the configured maximum cluster tier, Atlas raises the minimum cluster tier to the current cluster tier.

This auto-scaling logic reduces the downtime in cases when the storage settings don't match the workload.

In some embodiments, auto-scaling options can be configured when a cluster is created or modified. For new clusters, Atlas automatically enables cluster tier auto-scaling. Some embodiments allow the following:
Review and adjust the upper and lower cluster tiers that Atlas should use when auto-scaling a cluster, or
Opt out of using auto-scaling.

Atlas displays auto-scaling options in the Auto-scale section of the cluster builder for General and Low-CPU tier clusters.

In some embodiments, auto-scaling may be enabled by Atlas (e.g., by default). With auto-scaling enabled, a cluster can automatically:
Scale up to increase capability with a higher cluster tier.
Decrease the current cluster tier to a lower cluster tier.

In the Cluster tier section of the Auto-scale options, a user can specify the Maximum Cluster Size and Minimum Cluster Size values that a cluster can automatically scale to. Atlas sets these values as follows: (1) the Maximum Cluster Size is set to one tier above your current cluster tier, and (2) the Minimum Cluster Size is set to the current cluster tier.

In some embodiments, Atlas may provide an activity feed that logs auto-scaling events. In some embodiments, Atlas may generate alerts for auto-scaling events.

In some embodiments, a user may select a hardware capacity for a shard. For examples, a user may specify different dedicated cluster base tiers (i.e. M30+) and different dedicated cluster classes (i.e. general/low-CPU) for different shards. As another example, a user may specify asymmetric “base tier” and “analytics tier” within the same shard between the general and low-CPU cluster tier. As another example, a user may use an AWS API to specify between using standard IOPS vs provisioned IOPS for each shard. If the user specifies provisioned IOPS, the user may provision a different provisioned IOPS per shard. If the user stays on standard IOPS, the standard IOPS may be the fixed standard IOPS that comes with a cluster's storage size. As another example, a user may provision additional IOPS on top of a fixed IOPS that comes with a disk size.

In some embodiments, Atlas may scale base nodes differently than analytical nodes. For base nodes, if the Atlas auto-scaler determines that one base node in Shard A is scaled to the next base tier, it scales the base nodes in Shard A only, but not above the maximum base tier. If all the base nodes in Shard A meet the criteria for downscaling, the Atlas auto-scaler downscales the base nodes in Shard A only, but not below the minimum base tier. For analytics nodes, if the Atlas auto-scaler determines that an analytics node in Shard A is scaled to the next cluster tier, it scales all the analytics nodes in Shard A only, but not above the maximum analytics tier. If all the analytics nodes in Shard A meet the criteria for downscaling, the Atlas auto-scaler downscales the analytics nodes on Shard A only, but not below the minimum analytics tier. For Global Write clusters, asymmetry can be configured per shard within a Zone. Additional features include:
Provide a read-only view of the cluster tier per shard in the UI (outside of the cluster builder). For example, this information could be in the “Overview” page of the cluster.
If an existing multi-shard cluster is asymmetric and the user edits the configuration in the UI, the system informs the user that the changes may be applied to all the shards.
If an existing multi-shard cluster is asymmetric, the system informs the user the cluster is asymmetric. The UI can show the highest tier in the cluster builder but let the user know that there are shards on lower tiers than the one shown.
If an existing multi-shard cluster is asymmetric and a user disables auto-scale via the UI, the system converts the cluster back to a symmetric multi-shard cluster, on the highest tier in the cluster.
If an existing asymmetric multi-shard cluster adds additional shards to the cluster via the UI, the system clearly informs the user of the new shards' configurations (base tier, analytic tier if applicable, IOPS).
Defaults could be the highest base tier, analytic tier, or IOPS on any shards within the cluster.
If the user reduces the number of shards via the UI, system informs the user which shard(s) may be removed and the cluster tier the shard(s) are on.
Atlas can continue to remove the last shard in the cluster.
Any nodes exceeding the storage auto-scaling threshold can trigger the entire cluster's storage to increase.
Backup restore of asymmetric sharded clusters ensures to validate compatible target clusters. Someone takes a snapshot of 3 1 TB shards and tries to restore to a cluster with 2 1 TB shards and one 512 GB shard.
The system may tell the user when shards in the cluster are asymmetric. Additionally, if the user makes configuration changes via the UI, the system tells them that the same changes may be applied to all the shards, show the changes for each shards, and have them confirm before making the changes.

Some embodiments provide for sharded clusters where not all shards have the same compute tier and/or disk performance. To prevent a user of a database system from incurring costs unnecessarily by adding capacity to shards that don't require it, some embodiments allow different capacities per shard. Shards may be auto-scaled independently, and users may be able to use the API to deploy clusters with asymmetric shards.

Some embodiments update the current schema of the document that describes the goal state of a cluster, the clusterDescription. More specifically, the subdocuments and models that define the capacity of nodes in the cluster may be modified to hold different sets of properties, one per shard. Cluster tier defines compute and storage capabilities for all nodes in the cluster. It is expressed as different hardware specs (one per node type) in the ClusterDescription document:

```
□{
  ...
  “replicationSpecList”: [
    {
      “id” : {
        “$oid” : “653fd62f5fc98f7316e0ecd2”
      }
      “zoneName” : “EMEA”,
      “numShards” : 2,
      “regionConfigs”: [
        {
          ...
          “electableSpecs” : {
            ...
            “instanceSize” : “M10”,
            “diskIOPS”: 3000,
            ...
          },
          “readOnlySpecs”: {
            ...
            “instanceSize”: “M10”,
            “diskIOPS”: 3000,
            ...
          },
          “analyticsSpecs” : {
            ...
            “instanceSize” : “M10”,
            “diskIOPS”: 3000,
            ...
          },
          “hiddenSecondarySpecs” : {
            ...
            “instanceSize” : “M10”,
            “diskIOPS”: 500,
            ...
          }
        }
      ]
    }
  ],
  ...
}
```

Within the replicationSpec subdocument, the numShards field defines the number of shards in the zone. Previously, a single set of hardwareSpecs that all shards will share made it impossible for them to scale independently. Some embodiments change how the replicationSpec document is used today. Instead of representing a zone with one or more shards, a replicationSpec represents a single shard in a particular zone. Different shards on the same zone have their own replicationSpec document with the same value on their zoneName fields. Some embodiments include new fields. For example, the new fields may include three new fields: scalingStrategy, zoneId and externalId. Each of these three fields will be described below.

scalingStrategy

A new scalingStrategy field at the root level to specify whether the cluster is allowed to take an asymmetric geometry. Two values may be allowed for this field:
1. CLUSTER: scaling may be done taking into account metrics at the cluster level. All nodes in the cluster will have the same compute tier and disk properties.
2. SHARD: scaling strategy that allows different shards to be scaled independently based on shard-specific metrics.

In some embodiments, absence of the field may be interpreted as scalingStrategy: CLUSTER to preserve current behavior and avoid the need for a migration. The scalingStrategy field be used to establish defaults on rollout and may determine how the autoscaler and the API behave.

zoneID

Conventionally, a replicationSpec had a 1:1 relationship with a zone. Functionality interested in the concept of a zone could use the replicationSpec.id as an immutable identifier for a zone. In some embodiments, there may be several replicationSpecs in a zone, and a zone may not be identified by the replicationSpec.id.

Different replicationSpecs could be related to a given zone by means of zoneName. In some embodiments, the zoneName field can be changed by the user, which prevents its usage when storing state in other parts of the system (e.g., backup copy snapshots are associated with a zone, if a given snapshot uses zoneName to reference the applicable zone, and then zoneName is changed, that snapshot may lose the reference).

A new zoneId field is included. It may be assigned when the zone is created and immutable afterwards, decoupling it from the zoneName. It may be possible to refer to the zoneId to enumerate all the replicationSpecs belonging to a given zone.

externalId

replicationSpec.id may be used to identify a replicationSpec both internally and externally. Because of how config server embedding operate in asymmetric clusters, there are some cases that involve moving a data shard to the replicationSpec of a config server. Config server embedding may occur transparently to the user.

The solution to that is the introduction of a specific ID to be used by external API consumers (which includes customer tooling and integrations, such as Terraform or the Atlas Kubernetes Operator). The new externalId is decoupled from the replicationSpec.id, which allows rearranging shards internally while still exposing an equivalent view in the API.

| | |
|---|---|
| Before | After |
| □{ | □{ |
| ... | “scalingStrategy”: “SHARD”, |
| “replicationSpecList”: [ | ... |
| { | “replicationSpecList” : [ |
| “id”: { | { |
| “$oid”: “653fd62f5fc98f7316e0ecd2” | “id”: { |
| } | “$oid”: “653fd62f5fc98f7316e0ecd2” |
| “zoneName”: “EMEA”, | } |
| “numShards” : 2, | “externalId”: “65bd31e244744573d7a1e7fc”, |
| “regionConfigs”: [ | “zoneName” : “EMEA”, |
| { | “zoneId”: “65c35f55883ed504fb2170ee”, |
| ... | “numShards”: 1, |
| “electableSpecs” : { | “regionConfigs”: [ |
| ... | { |
| “instanceSize” : “M10”, | ... |
| “diskIOPS”: 3000, | “electableSpecs”: { |
| ... | ... |
| }, | “instanceSize”: “M10”, |
| ... | “diskIOPS”: 3000, |
| } | ... |
| ] | }, |
| } | ... |
| ], | } |
| ... | ] |
| } | }, |
| □ | { |
| | “id” : { |
| | “$oid”: “653fd62f5fc98f7316e0ecd3” |
| | } |
| | “externalId”: “65c3606959cc5c27a781b63a”, |
| | “zoneName” : “EMEA”, |
| | “zoneId”: “65c35f55883ed504fb2170ee”, |
| | “numShards”: 1, |
| | “regionConfigs”: [ |
| | { |
| | ... |
| | “electableSpecs”: { |
| | ... |
| | “instanceSize”: “M20”, |
| | “diskIOPS”: 5000, |
| | ... |
| | }, |
| | ... |
| | } |
| | ] |
| | } |
| | ], |
| | ... |
| | } |
| | □ |

In the example above, a replicationSpec representing two shards unfolds into two different replicationSpecs when the shards are scaled independently of each other. replicationSpecs for existing clusters can be split lazily when necessary. Because replicaSetHardware documents already have a replicationSpecId, adding a new id field is not required in order to link each shard with its backing hardware. Since each shard has its own replicationSpec document and, thus, its own full set of properties, there is greater flexibility to allow other values to be different among shards in the future, without requiring further changes to the model.

Some embodiments may provide an API with a schema capable of describing symmetric and asymmetric clusters. To be able to describe asymmetric cluster topologies, replicationSpecs may be split when the cluster is accessed via the API, even when the cluster is symmetric. A new field is introduced to allow grouping together replicationSpecs that belong to the same zone. The zoneId field is immutable. Once it is assigned on creation, it won't change even when zones are renamed. Therefore, zoneId provides a reliable mechanism to reference zones from other parts of the system.

The below examples illustrate the responses returned by different versions of the API to a GET request for a multi-cloud, geosharded cluster (only relevant fields shown).

### Symmetric Cluster

| | |
|---|---|
| Example 1 | Example 2 |
| □{ | □{ |
| ... | ... |
| “diskSizeGB” : 40.0, | [symbol] |
| ... | ... |
| “replicationSpecs” : [ | “replicationSpecs” : [ |
| { | { |
| “id” : “65bbeda32db70670e9ce0be1”, | “id” : “65bd2992659c151c2043820c”, |
| “numShards” : 2, | [symbol] |
| “zoneId”: “65bcf4fd3fc4383290790941”, | “zoneId”: “65bcf4fd3fc4383290790941”, |
| “zoneName” : “Zone 1”, | “zoneName” : “Zone 1”, |
| “regionConfigs” : [ | “regionConfigs” : [ |
| { | { |
| ... | ... |
| “analyticsSpecs” : { | “analyticsSpecs” : { |
| “instanceSize” : “M30”, | “instanceSize” : “M30”, |
| “diskIOPS” : 3000, | “diskIOPS” : 3000, |
| ... | “diskSizeGB”: 40.0, |
| }, | ... |
| “electableSpecs” : { | }, |
| “instanceSize” : “M30”, | “electableSpecs” : { |
| “diskIOPS” : 3000, | “instanceSize” : “M30”, |
| ... | “diskIOPS” : 3000, |
| }, | “diskSizeGB”: 40.0, |
| “readOnlySpecs” : { | ... |
| “instanceSize” : “M30”, | }, |
| “diskIOPS” : 3000, | “readOnlySpecs” : { |
| ... | “instanceSize” : “M30”, |
| }, | “diskIOPS” : 3000, |
| “regionName” : “US_EAST_1” | “diskSizeGB”: 40.0, |
| } | ... |
| ] | }, |
| }, | “regionName” : “US_EAST_1” |
| { | } |
| “id” : “65bbedaf7a1751f37fc5ec5f”, | ] |
| “numShards” : 2, | }, |
| “zoneId”: “65bcf54b3fc4383290790942”, | { |
| “zoneName” : “Zone 2“ | “id”: “65bcf5943fc4383290790947”, |
| “regionConfigs” : [ | [symbol] |
| { | zoneId”: “65bcf4fd3fc4383290790941”, |
| ... | “zoneName” : “Zone 1”, |
| “analyticsSpecs” : { | “regionConfigs” : [ |
| “instanceSize” : “M30”, | { |
| “diskIOPS” : 3000, | ... |
| ... | “analyticsSpecs” : { |
| }, | “instanceSize” : “M30”, |
| “electableSpecs” : { | “diskIOPS” : 3000, |
| “instanceSize” : “M30”, | “diskSizeGB”: 40.0, |
| “diskIOPS” : 3000, | ... |
| ... | }, |
| }, | “electableSpecs” : { |
| “readOnlySpecs” : { | “instanceSize” : “M30”, |
| “instanceSize” : “M30”, | “diskIOPS” : 3000, |
| “diskIOPS” : 3000, | “diskSizeGB”: 40.0, |
| ... | ... |
| }, | }, |
| “regionName” : “US_EAST_2“ | “readOnlySpecs” : { |
| } | “instanceSize” : “M30”, |
| ] | “diskIOPS” : 3000, |
| } | “diskSizeGB”: 40.0, |
| ] | ... |
| } | }, |
| □ | “regionName” : “US_EAST_1” |
| } | } |
| }, | ] |
| | }, |
| | { |
| | “id”: “65bd291fdf00c01eb0e98d5b”, |
| | [symbol] |
| | “zoneId”: “65bcf54b3fc4383290790942”, |
| | “zoneName” : “Zone 2” |
| | “regionConfigs” : [ |
| | { |
| | ... |
| | “analyticsSpecs” : { |
| | “instanceSize” : “M30”, |
| | “diskIOPS” : 3000, |
| | “diskSizeGB”: 40.0, |
| | ... |
| | }, |
| | “electableSpecs” : { |
| | “instanceSize” : “M30”, |
| | “diskIOPS” : 3000, |
| | “diskSizeGB”: 40.0, |
| | ... |
| | }, |
| | “readOnlySpecs” : { |
| | “instanceSize” : “M30”, |
| | “diskIOPS” : 3000, |
| | “diskSizeGB”: 40.0, |
| | ... |
| | }, |
| | regionName” : “US_EAST_2“ |
| | } |
| | ] |
| | }, |
| | { |
| | “id”: “65bcf69e3fc4383290790948”, |
| | [symbol] |
| | “zoneId”: “65bcf54b3fc4383290790942”, |
| | “zoneName” : “Zone 2” |
| | “regionConfigs” : [ |
| | { |
| | ... |
| | “analyticsSpecs” : { |
| | “instanceSize” : “M30”, |
| | “diskIOPS” : 3000, |
| | “diskSizeGB”: 40.0, |
| | ... |
| | }, |
| | “electableSpecs” : { |
| | “instanceSize” : “M30”, |
| | “diskIOPS” : 3000, |
| | “diskSizeGB”: 40.0, |
| | ... |
| | ,} |
| | “readOnlySpecs” : { |
| | “instanceSize” : “M30”, |
| | “diskIOPS” : 3000, |
| | “diskSizeGB”: 40.0, |
| | ... |
| | }, |
| | “regionName” : “US_EAST_2“ |
| | } |
| | ] |
| | } |
| | □ |

### Asymmetric Cluster

| | |
|---|---|
| Example 1 | Example 2 |
| □ERROR | □{ |
| □ | ... |
| | [symbol] |
| | ... |
| | “replicationSpecs” : [ |
| | { |
| | “id”: “65bd2992659c151c2043820c”, |
| | [symbol] |
| | “zoneId”: “65bcf4fd3fc4383290790941”, |
| | “zoneName” : “Zone 1”, |
| | “regionConfigs” : [ |
| | { |
| | ... |
| | “analyticsSpecs” : { |
| | “instanceSize” : “M30”, |
| | “diskIOPS” : 3000, |
| | “diskSizeGB”: 40.0, |
| | ... |
| | }, |
| | “electableSpecs” : { |
| | “instanceSize” : “M30”, |
| | “diskIOPS” : 3000, |
| | “diskSizeGB”: 40.0, |
| | ... |
| | }, |
| | “readOnlySpecs” : { |
| | “instanceSize” : “M30”, |
| | “diskIOPS” : 3000, |
| | “diskSizeGB”: 40.0, |
| | ... |
| | }, |
| | “regionName” : “US_EAST_1” |
| | } |
| | ] |
| | }, |
| | { |
| | “id”: “65bcf5943fc4383290790947”, |
| | [symbol] |
| | “zoneId”: “65bcf4fd3fc4383290790941”, |
| | “zoneName” : “Zone 1”, |
| | “regionConfigs” : [ |
| | { |
| | ... |
| | “analyticsSpecs” : { |
| | “instanceSize” : “M30”, |
| | “diskIOPS” : 3000, |
| | “diskSizeGB”: 40.0, |
| | ... |
| | }, |
| | “electableSpecs” : { |
| | “instanceSize”: “M50”, |
| | “diskIOPS”: 5000, |
| | “diskSizeGB”: 40.0, |
| | ... |
| | }, |
| | “readOnlySpecs” : { |
| | “instanceSize”: “M50”, |
| | “diskIOPS”: 5000, |
| | “diskSizeGB”: 40.0, |
| | ... |
| | }, |
| | “regionName” : “US_EAST_1“” |
| | } |
| | ] |
| | }, |
| | { |
| | “id”: “65bd291fdf00c01eb0e98d5b”, |
| | [symbol] |
| | “zoneId”: “65bcf54b3fc4383290790942”, |
| | “zoneName” : “Zone 2” |
| | “regionConfigs” : [ |
| | { |
| | ... |
| | “analyticsSpecs” : { |
| | “instanceSize” : “M30”, |
| | “diskIOPS” : 3000, |
| | “diskSizeGB”: 40.0, |
| | ... |
| | }, |
| | “electableSpecs” : { |
| | “instanceSize” : “M30”, |
| | “diskIOPS” : 3000, |
| | “diskSizeGB”: 40.0, |
| | ... |
| | }, |
| | “readOnlySpecs” : { |
| | “instanceSize” : “M30”, |
| | “diskIOPS” : 3000, |
| | “diskSizeGB”: 40.0, |
| | ... |
| | }, |
| | “regionName” : “US_EAST_2” |
| | } |
| | ] |
| | }, |
| | { |
| | “id”: “65bcf69e3fc4383290790948”, |
| | [symbol] |
| | “zoneId”: “65bcf54b3fc4383290790942”, |
| | “zoneName” : “Zone 2” |
| | “regionConfigs” : [ |
| | { |
| | ... |
| | “analyticsSpecs” : { |
| | “instanceSize” : “M30”, |
| | “diskIOPS” : 3000, |
| | “diskSizeGB”: 40.0, |
| | ... |
| | }, |
| | “electableSpecs” : { |
| | “instanceSize” : “M30”, |
| | “diskIOPS” : 3000, |
| | “diskSizeGB”: 40.0, |
| | ... |
| | }, |
| | “readOnlySpecs” : { |
| | “instanceSize” : “M30”, |
| | “diskIOPS” : 3000, |
| | “diskSizeGB”: 40.0, |
| | ... |
| | }, |
| | “regionName” : “US_EAST_2” |
| | } |
| | ] |
| | } |
| | □ |

The system includes new zoneId and externalId to existing replicationSpec subdocuments. They may be assigned newly allocated ObjectIds. The system supports both model shapes in the beginning, i.e. the numShards field is still allowed to have a value greater than 1 when shards are still symmetrical. The split of replicationSpecs may be done in a controlled way by means of a maintenance and the planner. There is also no need to backfill the scalingStrategy field, as a missing field may be interpreted as if a scalingStrategy: CLUSTER was present to preserve today's behavior.

To allow for greater control on the rollout of the feature, the code supports both models (clusters where all replicationSpecs have been split and those that still have “merged” replicationSpecs) for some time. This avoids the need of a migration and makes the transition easier.

In some embodiments, every cluster description has its replicationSpecs split sooner rather than later, even if it doesn't have to be that way from the very beginning. In some embodiments, the system split replicationSpec documents subject to a project-level feature flag (INDEPENDENT_SHARD_SCALING). This flag may be used to dictate the order of splitting during the rollout. The flag may be set by means of a maintenance, which will only be in charge of enabling the FF for a given percentage of projects that may be increased progressively. In some embodiments, it may be the planner where the actual split will take place (in doPrePlanStateUpdate), to take advantage of the planner lock. As part of the split, replicaSetHardwares may be updated to point to their corresponding replicationSpec (by updating replicatSetHardware.replicationSpecId). Some embodiments may not merge replicationSpecs back together, even if the cluster becomes symmetric again.

In some embodiments, when a user adds/removes shards, this can trigger the embedding of the config server. In some embodiments, this may apply to SHARDED cluster type, but not to GEOSHARDED cluster type (“Global sharded clusters in 8.0 will always have dedicated config servers”). On asymmetric clusters, in some embodiments, transition to embedded config server logic may perform:
When a shard is added, the system points config server hardware to the replication spec of the highest tier shard. If the shard being added is highest tier, the system points to the replication spec of that new shard to avoid draining.
When a shard is removed, instead of pointing config server hardware to the last remaining shard, the system points it to the remaining shard with the highest cluster tier.

This means that embedding config server on an asymmetric cluster can result in gaps in rs ids and shard hostnames. For example, if a system has a cluster with 4 shards shard-{0 . . . 3} and dedicated config server config-0, and shard-1 has the highest tier, when one shard is removed (which will trigger config server embedding), we will end up with the following shards: shard-0, shard-2, config-0. Where shard-3 was removed by the user and shard-1 was removed by the embedding of the config server. The gaps in rs ids and node hostnames can already occur in other scenarios today, e.g. when removing a zone in a global cluster or a node in a multi-region cluster.

In some embodiments, the system may implement a guardrail to limit maximum allowed gap between shard tiers in an asymmetric cluster. This limit may be enforced on cluster creation and shard downscale (by auto-scaler). In some embodiments, the limit may not be enforced during shard upscale. The system may define this as a group limit called MAX_SHARD_DOWNSCALE_TIERS. In some embodiments, the default limit may be 2, meaning a shard can be downscaled 2 tiers relative to the highest tier shard in the cluster. In some embodiments, clusters may be allowed to have shards with tier gap larger than the limit, as long as that gap results from shard upscale operation. If a cluster already has a shard tier gap larger than the limit, the system may allow shard downscaling if downscale operation reduces the gap, even if the gap still remains above the limit. For example, if cluster has shards M50, M400, we will allow downscaling to M50, M200.

Some embodiments may be configured to provide GUI that shows a visualization of asymmetric clusters in those places where replication specs get rendered, such as in a cluster view in the search.

Some embodiments may be configured to track one or more of:
Number of asymmetric clusters created (e.g., via the API and the UI).
Number of clusters transitioning from symmetric to asymmetric, along with an indication of the reason (e.g. shard auto-scaling, request via the API, request via the UI).
   Including shard, cluster, group, from size+to size
Number of clusters transitioning from asymmetric to symmetric, along with an indication of the reason (e.g. shard auto-scaling, request via the API, request via the UI).
   Including shard, cluster, group, from size+to size
      In some embodiments, compute tier and disk IOPS may be scaled independently. Besides, only General and Low-CPU classes may be affected in phase 1. Support for independent scaling of other specs and NVMe nodes may be implemented in future phases.

In some embodiments, symmetric clusters (clusters using cluster-level scaling) and asymmetric clusters (clusters using independent shard scaling) may coexist. In some embodiments, every cluster may automatically be transitioned to independent shard scaling.

In some embodiments, independent sharding may include the following features:
The system adds a new ID field (zoneId) to the existing API
   the externalId field includes the generated id that may be used in the new api version
The system releases new API version
   zoneId and id field and also releases independent sharding functionality
   New replicationSpecsList format introduced to support independent shards with an array entry per shard
   Customer adds a new shard entry to replication_specs
      Same region_configs.region_name supported
      Different instance_size can be specified

### Example Computer System

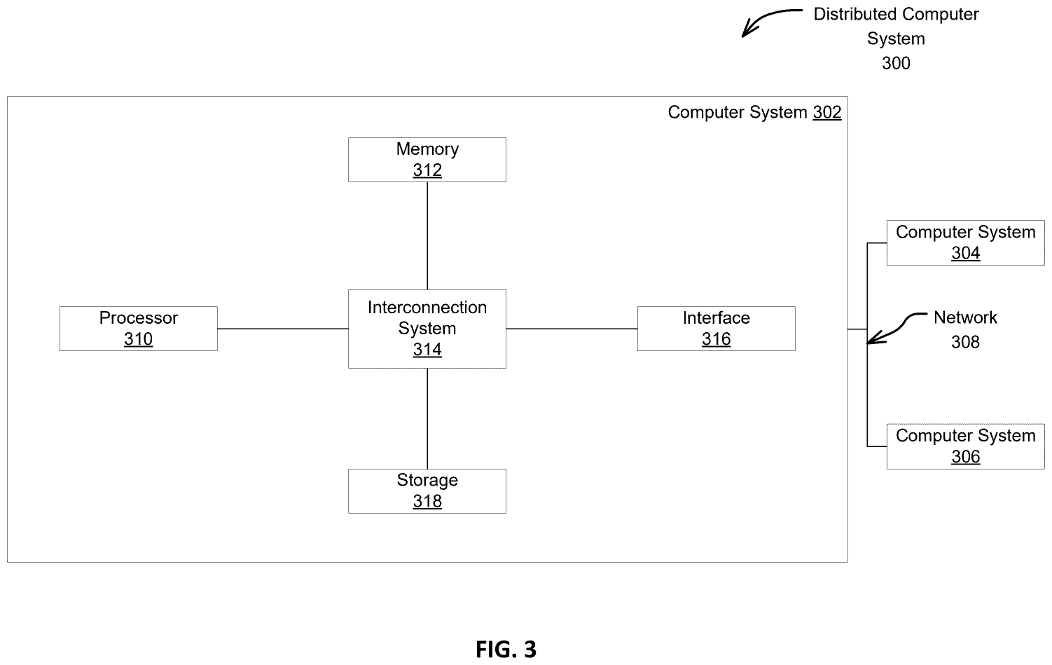

FIG. 3 shows a block diagram of an exemplary distributed computer system 300 improved by the implementation of any functions and/or operations of embodiments of the technology described herein. As shown, the distributed computer system 300 includes one or more computer systems that exchange information. More specifically, the distributed computer system 300 includes computer systems 302, 304, and 306. As shown, the computer systems 302, 304, and 306 are interconnected by, and may exchange data through, a communication network 308. The network 308 may include any communication network through which computer systems may exchange data. To exchange data using the network 308, the computer systems 302, 304, and 306 and the network 308 may use various methods, protocols, and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS3, JSON, SOAP, CORBA, REST, and Web Services. To ensure data transfer is secure, the computer systems 302, 304, and 306 may transmit data via the network 308 using a variety of security measures including, for example, SSL or VPN technologies. While the distributed computer system 300 illustrates three networked computer systems, the distributed computer system 300 is not so limited and may include any number of computer systems and computing devices, networked using any medium and communication protocol.

As illustrated in FIG. 3, the computer system 302 includes a processor 310, a memory 312, an interconnection element 314, an interface 316 and data storage element 318. To implement at least some of the aspects, functions, and processes disclosed herein, the processor 310 performs a series of instructions that result in manipulated data. The processor 310 may be any type of processor, multiprocessor, or controller. Example processors may include a commercially available processor such as an Intel Xeon, Itanium, Core, Celeron, or Pentium processor; an AMD Opteron processor; an Apple A3 or A5 processor; a Sun UltraSPARC processor; an IBM Power5+ processor; an IBM mainframe chip; or a quantum computer. The processor 310 is connected to other system components, including one or more memory devices 312, by the interconnection element 314.

The memory 312 stores programs (e.g., sequences of instructions coded to be executable by the processor 310) and data during operation of the computer system 302. Thus, the memory 312 may be a relatively high performance, volatile, random access memory such as a dynamic random access memory (“DRAM”) or static memory (“SRAM”). However, the memory 312 may include any device for storing data, such as a disk drive or other nonvolatile storage device. Various examples may organize the memory 312 into particularized and, in some cases, unique structures to perform the functions disclosed herein. These data structures may be sized and organized to store values for particular data and types of data.

Components of the computer system 302 are coupled by an interconnection element such as the interconnection mechanism 314. The interconnection element 314 may include any communication coupling between system components such as one or more physical busses in conformance with specialized or standard computing bus technologies such as IDE, SCSI, PCI, and InfiniBand. The interconnection element 314 enables communications, including instructions and data, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and to communicate with external entities, such as users and other systems.

The data storage element 318 includes a computer readable and writeable nonvolatile, or non-transitory, data storage medium in which instructions are stored that define a program or other object that is executed by the processor 310. The data storage element 318 also may include information that is recorded, on or in, the medium, and that is processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk, or flash memory, among others. In operation, the processor 310 or some other controller causes data to be read from the nonvolatile recording medium into another memory, such as the memory 312, that allows for faster access to the information by the processor 310 than does the storage medium included in the data storage element 318. The memory may be located in the data storage element 318 or in the memory 312, however, the processor 310 manipulates the data within the memory, and then copies the data to the storage medium associated with the data storage element 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows 3 or 11 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Java, C++, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML, or other formats, when viewed in a window of a browser program, can render aspects of a graphical-user interface, or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Having thus described several aspects of at least one embodiment of the technology described herein, it is to be appreciated that various alterations, modifications, and improvements will readily occur to those skilled in the art.

Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively, or additionally, aspects of the technology described herein may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion amongst a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 3 and 7. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by an “actor” or a “user.” It should be appreciated that an “actor” or a “user” need not be a single individual, and that in some embodiments, actions attributable to an “actor” or a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A system for scaling hardware capacity in a distributed database system configured to store data divided among a plurality of data partitions, the distributed database system comprising database hardware for hosting the plurality of data partitions, the system comprising:
at least one processor; and
at least one non-transitory computer-readable storage medium storing instructions that, when executed by the at least one processor, cause the at least one processor to:
determine, for each of at least some of the plurality of data partitions, a hardware capacity for hosting the data partition, the determining comprising:
determine a first hardware capacity for hosting a first data partition of the plurality of data partitions; and
determine a second hardware capacity, different from the first hardware capacity, for hosting a second data partition of the plurality of data partitions; and
configure the database hardware based on hardware capacities determined for hosting the at least some data partitions, the configuring comprising:
configure a first set of the database hardware, having the first hardware capacity, to host the first data partition; and
configure a second set of the database hardware having the second hardware capacity to host the second data partition.

2. The system of claim 1, wherein:
configuring the first set of database hardware, having the first hardware capacity, to host the first data partition comprises configuring database hardware with first computer processing unit (CPU) hardware to host the first data partition; and
configuring the second set of database hardware, having the second hardware capacity, to host the second data partition comprises configuring database hardware with second CPU hardware, different from the first CPU hardware, to host the second data partition.

3. The system of claim 1, wherein:
configuring the first set of database hardware, having the first hardware capacity, to host the first data partition comprises configuring database hardware with a first amount of random access memory (RAM) to host the first data partition; and
configuring the second set of database hardware, having the second hardware capacity to host the second data partition comprises configuring database hardware with a second amount of RAM, different from the first amount of RAM, to host the second data partition.

4. The system of claim 1, wherein determining the first hardware capacity for hosting the first data partition comprises:
analyze operations performed on the first data partition over a time period to determine an indication of memory utilization during the time period; and
determine the first hardware capacity based on the indication of memory utilization during the time period.

5. The system of claim 1, wherein determining the first hardware capacity for hosting the first data partition comprises modifying a previous hardware capacity determined for hosting the first data partition.

6. The system of claim 5, wherein modifying the previous hardware capacity for hosting the first data partition comprises increasing the previous hardware capacity for hosting the first data partition.

7. The system of claim 5, wherein modifying the previous hardware capacity for hosting the first data partition comprises decreasing the previous hardware capacity for hosting the first data partition.

8. The system of claim 1, wherein:
the first data partition is replicated across a plurality of nodes; and
the instructions further cause the at least one processor to:
determine a hardware capacity for a first node of the plurality of nodes; and
determine a hardware capacity for a second node of the plurality of nodes, wherein the hardware capacity determined for the second node is different from the hardware capacity of the determined for the first node; and
configure the first set of database hardware to host the first node using the hardware capacity determined for the first node and to host the second node using the hardware capacity determined for the second node.

9. The system of claim 1, wherein determining the first hardware capacity for hosting the first data partition comprises:
selecting the first hardware capacity from among a plurality of hardware capacities that the database hardware is configurable to provide.

10. The system of claim 9, wherein each of the plurality of hardware capacities comprises a specification of at least one of:
CPU hardware to be used to host a data partition; and
an amount of RAM to be used to host a data partition.

11. A method for scaling hardware capacity in a distributed database system configured to store data divided among a plurality of data partitions, the distributed database system comprising database hardware for hosting the plurality of data partitions, the method comprising:
using at least one processor to perform:
determining, for each of at least some of the plurality of data partitions, a hardware capacity for hosting the data partition, the determining comprising:
determining a first hardware capacity for hosting a first data partition of the plurality of data partitions; and
determining a second hardware capacity, different from the first hardware capacity, for hosting a second data partition of the plurality of data partitions; and
configuring the database hardware based on hardware capacities determined for hosting the at least some data partitions, the configuring comprising:
configuring a first set of the database hardware, having the first hardware capacity, to host the first data partition; and
configuring a second set of the database hardware having the second hardware capacity to host the second data partition.

12. The method of claim 11, wherein:
configuring the first set of database hardware, having the first hardware capacity, to host the first data partition comprises configuring database hardware with first computer processing unit (CPU) hardware to host the first data partition; and
configuring the second set of database hardware, having the second hardware capacity, to host the second data partition comprises configuring database hardware with second CPU hardware, different from the first CPU hardware, to host the second data partition.

13. The method of claim 11, wherein:
configuring the first set of database hardware, having the first hardware capacity, to host the first data partition comprises configuring database hardware with a first amount of random access memory (RAM) to host the first data partition; and
configuring the second set of database hardware, having the second hardware capacity to host the second data partition comprises configuring database hardware with a second amount of RAM, different from the first amount of RAM, to host the second data partition.

14. The method of claim 11, wherein determining the first hardware capacity for hosting the first data partition comprises:
analyzing operations performed on the first data partition over a time period to determine an indication of memory utilization during the time period; and
determining the first hardware capacity based on the indication of memory utilization during the time period.

15. The method of claim 11, wherein determining the first hardware capacity for hosting the first data partition comprises modifying a previous hardware capacity determined for hosting the first data partition.

16. The method of claim 11, wherein determining the first hardware capacity for hosting the first data partition comprises:
selecting the first hardware capacity from among a plurality of hardware capacities that the database hardware is configurable to provide.

17. A distributed database system configured to store data divided among a plurality of data partitions, the distributed database system comprising:
database hardware configured to host the plurality of data partitions, wherein the database hardware is configurable to provide different hardware capacities for hosting different data partitions; and
at least one processor configured to dynamically modify a configuration of the database hardware to update a hardware capacity used to host a particular data partition of the plurality of data partitions.

18. The distributed database system of claim 17, wherein the at least one processor is configured to modify a configuration of the database hardware to update the hardware capacity used to host the particular data partition based on a record of operations performed on the particular data partition over a time period.

19. The distributed database system of claim 18, wherein the at least one processor is configured to modify the configuration of the database hardware to update the hardware capacity used to host the particular data partition based on the record of operations performed on the particular data partition over the time period by performing:
determine a memory utilization of the operations performed on the at least one data partition over the time period;
modify the configuration of the database hardware to update the hardware capacity used to host the particular data partition based on the memory utilization.

20. The distributed database system of claim 19, wherein modifying the configuration of the database hardware to update the hardware capacity used to host the particular data partition comprises:
determine whether the memory utilization meets a threshold memory utilization; and
trigger the modification of the configuration of the database hardware to update the hardware capacity used to host the particular data partition in response to determining that the memory utilization meets the threshold memory utilization.
